(19) United States
(12) Patent Application Publication
(10) Pub. No.: US 2010/0177341 A1
(43) Pub. Date: Jul. 15, 2010

(54) WORKFLOW MANAGEMENT SYSTEM AND WORKFLOW MANAGEMENT METHOD

(75) Inventor: Makoto Mihara, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/646,057

(22) Filed: Dec. 23, 2009

(30) Foreign Application Priority Data
Jan. 9, 2009 (JP) 2009-003957

(51) Int. Cl. G06F 3/12

(52) U.S. Cl. 358/1.15

(57) ABSTRACT

A method for managing a workflow executed in a workflow management system which includes a client apparatus which a user instructs to perform workflow processing, a workflow management server configured to execute the workflow based on an instruction from the client apparatus, and an image processing apparatus which includes the user-specific portal screen, and has a function of registering or deleting an operation button for executing scanning and transmission or printing displayed on the portal screen based on an instruction from the workflow management server. The method includes aggregating setting information about a plurality of the operation buttons, storing the aggregated operation button setting information and a plurality of work items corresponding to the aggregated operation button setting information by associating each other, and registering an operation button for executing an aggregated work item in the portal screen based on the aggregated operation button setting information.

### BACKGROUND OF THE INVENTION

1. Field of the Invention

The present invention relates to a workflow management server, a workflow management system, a workflow management method, and a workflow management program.

2. Description of the Related Art

In recent years, there has been discussed a system, such as voucher scan solution, for automating a series of workflows from drafting to application, approval, and settlement in various types of business. The system is realized by scanning a voucher document and carrying the scanned document as an accompanying document along with work data in the workflow. For example, in a workflow of transportation expenses application, transportation expenses application processing may be performed using a receipt as an accompanying document which is scanned by using a scanning function of an image processing apparatus.

Japanese Patent Application Laid-Open No. 2005-50318 discusses, as such a workflow management system, a document management apparatus in which a plurality of user interfaces (denoted as “UI” below) is prepared to enable each terminal to confirm document information in other document management apparatuses connected thereto via a network. The document management apparatus displays a screen according to a user's execution environment such as personal computer (PC) terminal, mobile terminal, and multifunction peripheral (MFP).

Japanese Patent Application Laid-Open No. 2005-57600 discusses an image transmission apparatus for collectively managing common parts in a plurality of different processes and improving efficiency of the processes.

However, since generally a terminal UI in the document management apparatus discussed in Japanese Patent Application Laid-Open No. 2005-50318 cannot display many items of information thereon, there is a problem that various keys for work items cannot be displayed on the terminal UI, which causes low operability and complicated work in searching for a desired key. Further, there is a problem that a user has to press a key many times to continuously process similar work items.

There is a problem that although the image transmission apparatus discussed in Japanese Patent Application Laid-Open No. 2005-57600 can, when performing the plurality of processes on specific data, collectively manage common parts of the processes for handling the processes at the same time, the apparatus cannot be adapted to collectively process different work items.

### SUMMARY OF THE INVENTION

According to a workflow management method of the present invention, when operation buttons for executing work items are registered in an image processing apparatus, it is possible to aggregate registration of the operation buttons or management information if an aggregatable work item is present.

According to an aspect of the present invention, a workflow management server which can be connected to a network and manage a workflow to be executed in an image processing apparatus connected to the network includes an execution function setting unit configured to set a function to be executed in the image processing apparatus according to an activity which is a work unit in a workflow and corresponds to a work item as specific work to be executed by a user, a user information acquisition unit configured to acquire information about a user who is allowed to execute the work item from a role assigned to the work item, an operation button information generation unit configured to generate information for determining setting contents of an operation button to be registered in a portal screen of the image processing apparatus based on the work item and the user information acquired by the user information acquisition unit, an aggregation condition determination unit configured to determine whether the work item satisfies previously set aggregation conditions, an aggregated work item detection unit configured to detect whether an aggregatable work item is present, an operation button deletion unit configured to delete an operation button associated with a work item to be aggregated which is previously registered in the portal screen of the image processing apparatus, an aggregated work item's operation button information generation unit configured to generate information for determining setting contents of an operation button for executing an aggregated work item registered in the portal screen of the image processing apparatus based on the information generated by the operation button information generation unit according to a detection result of the aggregated work item detection unit, and a communication unit configured to transmit the information generated by the aggregated work item's operation button information generation unit to the image processing apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of a workflow management system according to an exemplary embodiment of the present invention.

FIG. 2 is a block diagram illustrating a hardware configuration of a workflow management server according to the exemplary embodiment of the present invention.

FIG. 3 is a block diagram illustrating a functional configuration of the workflow management server according to the exemplary embodiment of the present invention.

FIG. 4 is a block diagram illustrating a functional configuration of a work item execution preprocessing unit.

FIG. 5 is a block diagram illustrating a functional configuration of a work item aggregation processing unit.

FIG. 6 is a block diagram illustrating a functional configuration of a work item execution monitoring unit.

FIG. 7 is a block diagram illustrating a configuration of an image processing apparatus according to the exemplary embodiment of the present invention.

FIG. 8 illustrates an example of a process definition of a workflow according to the exemplary embodiment of the present invention.

FIG. 9 illustrates an example of a relationship between a role and a user for the workflow of FIG. 8.

FIG. 10 is a schematic diagram illustrating an operation flow of a workflow management system according to the exemplary embodiment of the present invention.

FIG. 11 illustrates an example of a portal screen which is displayed on an image processing apparatus according to the exemplary embodiment of the present invention.

FIG. 12 is a flowchart illustrating processings of a workflow management program after a new work item generates and until a button setting is distributed.

FIG. 13 is a flowchart for describing preprocessing of the flowchart of FIG. 12 in detail.

FIG. 14 is a flowchart for describing work item aggregation processing in the flowchart of FIG. 12 in detail.

FIG. 15 illustrates information data on work items managed by the workflow management server according to the exemplary embodiment of the present invention.

FIG. 16 illustrates information data on aggregated work items managed by the workflow management server according to the exemplary embodiment of the present invention.

FIGS. 17A and 17B illustrate examples (for scanning and transmission work item) of registering an operation button distributed to the image processing apparatus according to the exemplary embodiment of the present invention.

FIGS. 18A and 18B illustrate example (for print work item) of registering an operation button distributed to the image processing apparatus according to the exemplary embodiment of the present invention.

FIG. 19 is a flowchart for describing execution monitor processing according to the exemplary embodiment of the present invention and processing after the execution monitor processing ends.

FIG. 20 illustrates an example of information data of the image processing apparatus according to the exemplary embodiment of the present invention.

FIG. 21 is a flowchart for describing another exemplary embodiment of the processing of FIG. 15.

### DESCRIPTION OF THE EMBODIMENTS

Various exemplary embodiments, features, and aspects of the invention will be described in detail below with reference to the drawings.

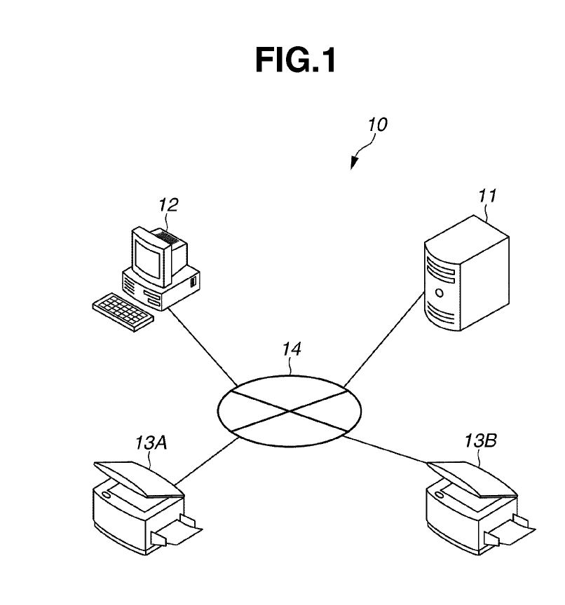

FIG. 1 illustrates a schematic configuration of a workflow management system according to an exemplary embodiment of the present invention. The workflow management system 10 includes a workflow management server 11, a client apparatus 12, and image processing apparatuses 13A and 13B.

The workflow management server 11 is a computer for managing workflow processing and managing the image processing apparatuses 13A and 13B. The client apparatus 12 is a computer by which a user inputs various instructions to the workflow management server 11. The image processing apparatus 13A and 13B are a multifunction peripheral including a user interface capable of displaying a user-specific portal screen, and a printer and scanner for inputting and outputting an image. The word “portal” means an entry, and the portal screen indicates a screen which is first viewed when the user utilizes the image processing apparatus.

Each of the apparatuses configuring the workflow management system 10 is connected with each other via a network 14 and can use a protocol such as Transmission Control Protocol/Internet Protocol (TCP/IP) or Simple Network Management Protocol (SNMP) to perform data communication.

A number of respective apparatuses are not limited in the workflow management system 10. There will be assumed in the exemplary embodiment that one workflow management server 11, one client apparatus 12, and two image processing apparatuses 13A, and 13B are connected. For example, the image processing apparatus maybe a computer multifunction peripheral incorporating the client apparatus therein.

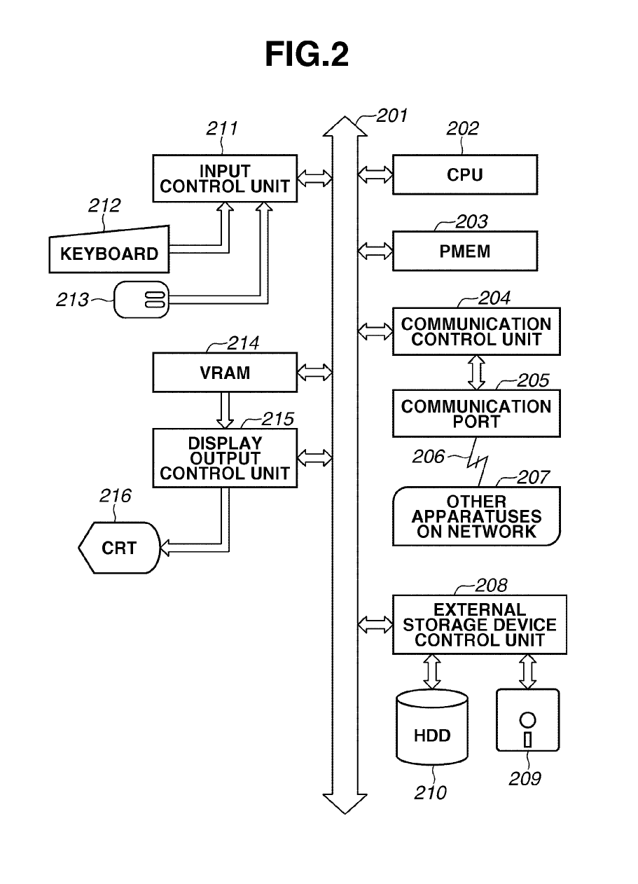

FIG. 2 is a block diagram illustrating a hardware configuration of the workflow management server 11 according to the exemplary embodiment of the present invention. The workflow management server 11 includes a central processing unit (CPU) 202, a program memory (referred to as “PMEM” below) 203, a communication control unit 204, and a communication port 205.

A system bus 201 connects to each block configuring the workflow management server 11. The CPU 202 executes a workflow management program. The PMEM 203 appropriately selects and reads the program from a hard disk 210 described below. The PMEM 203 stores therein a text code input from a keyboard 212 described below as code information.

The communication control unit 204 controls the data input and output via the communication port 205. A signal output from the communication port 205 is transmitted to other apparatus on the network via a communication line 206. The communication port 205 and the communication line 206 connected to the communication control unit 204 can be adapted even to a typical public line.

The workflow management server 11 further includes an external storage device control unit 208 for controlling a magnetic storage medium described below, a flexible disk (FD) 209 as a magnetic storage medium for storing a data file therein, and a hard disk (HDD) 210. The workflow management program is stored in a magnetic storage medium such as the FD 209 or the HDD 210. The workflow management program may be stored in other apparatus connected via the network.

Further, the workflow management server 11 includes an input control unit 211 for controlling an instruction by an input device described below, a keyboard 212, and a mouse 213 as input devices. A user operates the input devices to issue various instructions to the workflow management system 10. The workflow management server 11 includes a video image memory (referred to as “VRAM” below) 214, a display output control unit 215 for controlling an image displaying apparatus, and a cathode ray tube (CRT) 216 as the image displaying apparatus.

An instruction of processing image information displayed on the CRT 216 is input via the mouse 213 as a pointing device. More specifically, the user moves a cursor displayed on the CRT 216 via the mouse 213 in arbitrary X and Y directions and selects a command icon on a command menu for instruction of a workflow processing, and further issues an instruction for edition target and a drawing position. The VRAM 214 is used for rendering data to be displayed on the CRT 216 as bit map data.

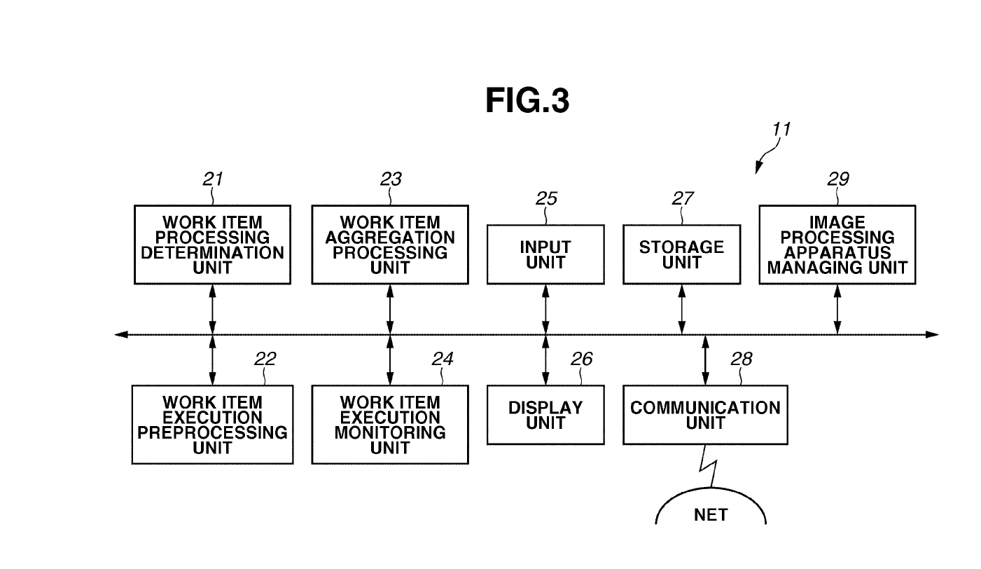

FIG. 3 is a block diagram illustrating a functional configuration of the workflow management server 11 according to the exemplary embodiment of the present invention. The workflow management server 11 includes a work item processing determination unit 21, a work item execution preprocessing unit 22, a work item aggregation processing unit 23, and a work item execution monitoring unit 24. Further, the workflow management server 11 includes an input unit 25, a display unit 26, a storage unit 27, a communication unit 28, and an image processing apparatus management unit 29. The “work item” indicates a specific work executed by the user in an activity. The “activity” is used as a unit of work in the workflow (described below in detail).

The work item processing determination unit 21 determines whether a designated work item is to be processed in the image processing apparatus. The work item execution preprocessing unit 22 executes preprocessing (preparation processing) of the work item to be executed in the image processing apparatus. The work item aggregation processing unit 23 performs a work item aggregation processing. The work item execution monitoring unit 24 monitors a work item execution status. The CPU 202 illustrated in FIG. 2 executes the workflow management programs, so that the above described functions are realized. The processings will be described below in detail.

The input unit 25 is directed for inputting information into the workflow management server 11. The input unit 25 can realize its function via the input control unit 211, the keyboard 212, or the mouse 213 illustrated in FIG. 2. The display unit 26 displays various items of information thereon. The display unit 26 can realize its function via the VRAM 214, the display output control unit 215, or the CRT 216 illustrated in FIG. 2. The storage unit 27 stores therein various items of data. The storage unit 27 can realize its function via the PMEM 203, the external storage device control unit 208, the FD 209, or the HDD 210 illustrated in FIG. 2.

The communication unit 28 controls communication between the workflow management server 11 and the network 14. The communication unit 28 can realize its function via the communication control unit 204 or the communication port 205 illustrated in FIG. 2. The image processing apparatus management unit 29 performs information data management for collectively managing a plurality of image processing apparatuses connected to the workflow management server 11 via the network 14. The CPU 202 illustrated in FIG. 2 executes the workflow management program so that the image processing apparatus management unit 29 can realize its function.

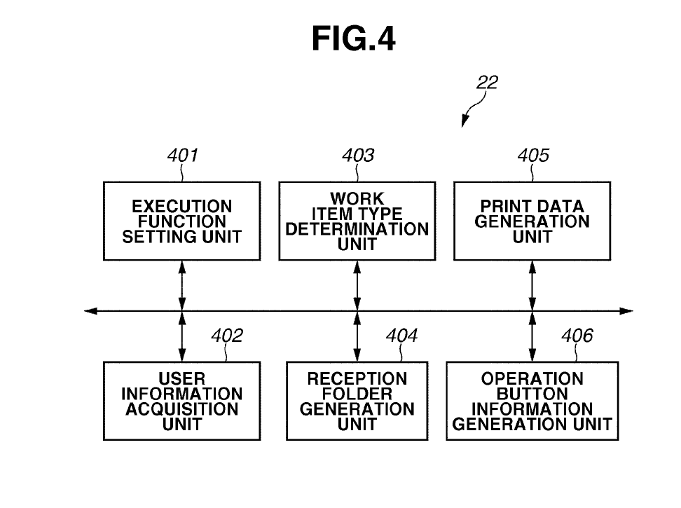

FIG. 4 is a block diagram illustrating a functional configuration of the work item execution preprocessing unit 22. The work item execution preprocessing unit 22 includes an execution function setting unit 401, a user information acquisition unit 402, a work item type determination unit 403, a reception folder generation unit 404, a print data generation unit 405, and an operation button information generation unit 406.

The execution function setting unit 401 sets the functions to be executed in the image processing apparatus via the activities corresponding to the work items. The setting includes resolution in scanning an image, a color/monochrome setting, a scanned data file generation method, a print form (such as N-up or staple), and the like, for example.

The user information acquisition unit 402 acquires information (authority) about the user who is allowed to execute a work item from a role assigned to the work item.

The work item type determination unit 403 determines a type of a work item. More specifically, the work item type determination unit 403 determines whether the work item is for scanning and transmission or for printing. The reception folder generation unit 404 generates a reception folder for receiving scanned and transmitted data when the determination result of the work item type determination unit 403 indicates the work item for scanning and transmission.

The print data generation unit 405 generates print data when the determination result of the work item type determination unit 403 indicates the work item for printing. The operation button information generation unit 406 generates information for determining setting contents of the operation buttons to be registered in the portal screen of the image processing apparatus. The setting contents of the operation buttons refer to execution contents of the workflow such as scanning and transmission or print. This processing is executed based on the work item and user information associated therewith acquired by the user information acquisition unit 402.

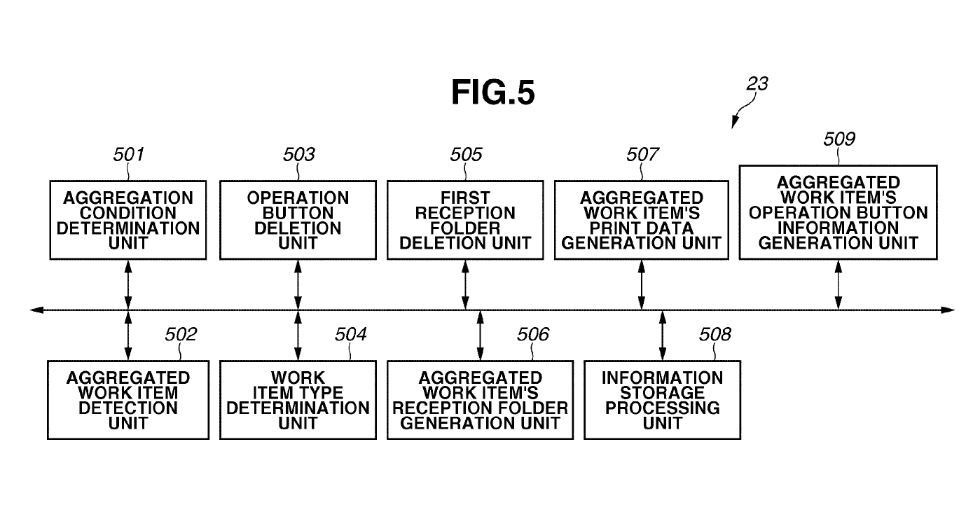

FIG. 5 is a block diagram illustrating a functional configuration of the work item aggregation processing unit 23. The work item aggregation processing unit 23 includes an aggregation condition determination unit 501, an aggregated work item detection unit 502, an operation button deletion unit 503, a work item type determination unit 504, and a first reception folder deletion unit 505. The work item aggregation processing unit 23 further includes an aggregated work item's reception folder generation unit 506, an aggregated work item's print data generation unit 507, an information storage processing unit 508, and an aggregated work item's operation button information generation unit 509.

The aggregation condition determination unit 501 determines whether a work item satisfies the aggregation conditions. The aggregation conditions include (1) to absolutely aggregate aggregatable operation buttons, (2) to aggregate when the operation buttons cannot be all displayed on one screen, and (3) to aggregate based on a timing of generating a work item such as an old work item.

The aggregated work item detection unit 502 detects whether an aggregatable work item is present. The “aggregatable work item” refers to a work item of the same activity in the workflow executed in the same process definition.

The operation button deletion unit 503 deletes an operation button associated with the work item to be aggregated, which is previously registered in the portal screen of the image processing apparatus. The work item type determination unit 504 determines a type of a work item. More specifically, the work item type determination unit 403 determines whether the work item is for scanning and transmission or for printing. The processing may be performed by the work item type determination unit 403 of the work item execution preprocessing unit 22 illustrated in FIG. 4.

When the work item is for scanning and transmission, the first reception folder deletion unit 505 deletes a scanned document's reception folder of a work item corresponding to the button deleted by the operation button deletion unit 503. The aggregated work item's reception folder generation unit 506 creates a scanned document's reception folder for the aggregated work item.

When the work item is for printing, the aggregated work item's print data generation unit 507 generates print data corresponding to an aggregated work item. The information storage processing unit 508 stores the aggregated work item and the workflow information in the storage unit 27 in an associated manner. The aggregated work item's operation button information generation unit 509 generates information for determining the setting contents of the operation buttons for executing the aggregated work item to be registered in the portal screen of the image processing apparatus. The information is generated based on the information generated by the operation button information generation unit 406 via the detection result of the aggregated work item detection unit 502. Then, the information is transmitted to the image processing apparatus by the communication unit 28.

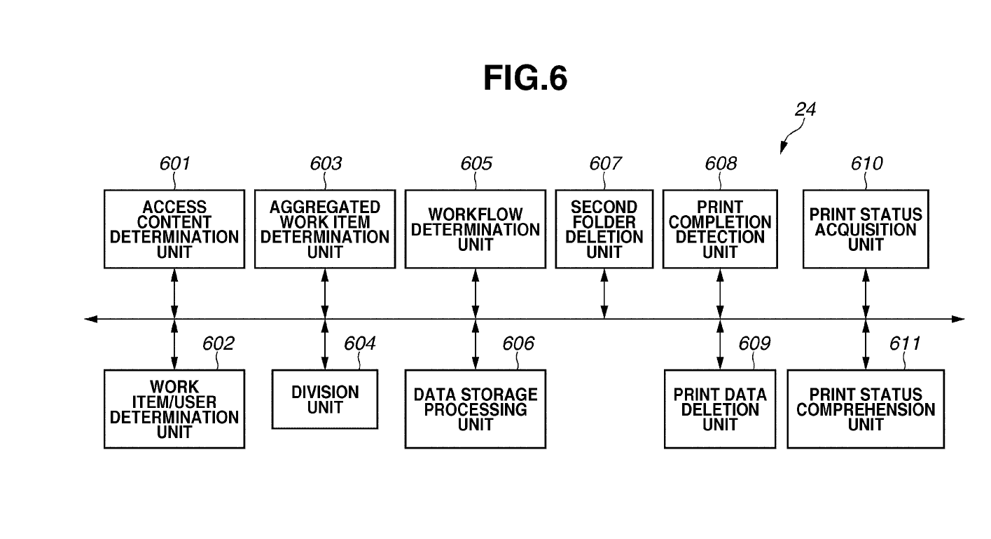

FIG. 6 is a block diagram illustrating a functional configuration of the work item execution monitoring unit 24. The work item execution monitoring unit 24 includes an access content determination unit 601, a work item/user determination unit 602, an aggregated work item determination unit 603, a division unit 604, and a workflow determination unit 605. The work item execution monitoring unit 24 further includes a data storage processing unit 606, a second reception folder deletion unit 607, a print completion detection unit 608, a print data deletion unit 609, a print status acquisition unit 610, and a print status comprehension unit 611.

The access content determination unit 601 determines access contents from the image processing apparatus 13A (13B). More specifically, the access content determination unit 601 determines whether the scanned data has been transmitted or the print data has been requested to acquire.

The work item/user determination unit 602 detects, when the scanned data is received, a corresponding work item or aggregated work item from the access folder from which the data has been transmitted. At the same time, the work item/user determination unit 602 specifies a user who has executed the work item from the information about the user who has accessed the folder. On the other hand, in the case of a request to acquire the print data, the corresponding work item or aggregated work item is detected from the requested print data. At the same time, the user who has executed the work item is specified from the information about the user who has accessed the data.

The aggregated work item determination unit 603 determines whether the work item is aggregated. When the work item is aggregated, the division unit 604 divides the received scan data to correspond to the unaggregated work item. The process will be described below in detail.

The workflow determination unit 605 determines the entire workflow corresponding to the work items. The data storage processing unit 606 stores the scanned data by associating with the workflow. The second reception folder deletion unit 607 deletes the reception folder generated by the reception folder generation unit 404 or the aggregated work item's reception folder generation unit 506.

The print completion detection unit 608 detects that print processing of the image processing apparatus has been completed. The print data deletion unit 609 deletes the print data. The print status acquisition unit 610 acquires a status when the print processing of the image processing apparatus ended. More specifically, the workflow management server 11 determines whether the print processing has normally ended, and if not normally ended, acquires a status indicating how many pages have been printed.

The print status comprehension unit 611 determines whether the print processing has normally ended. When the print processing ended in error, the print status comprehension unit 611 comprehends how many work items have been completed from the print end page. In this case, the operation button deletion unit 503 (see FIG. 5) deletes an operation button relating to the processing which is previously registered in the portal screen of the image processing apparatus.

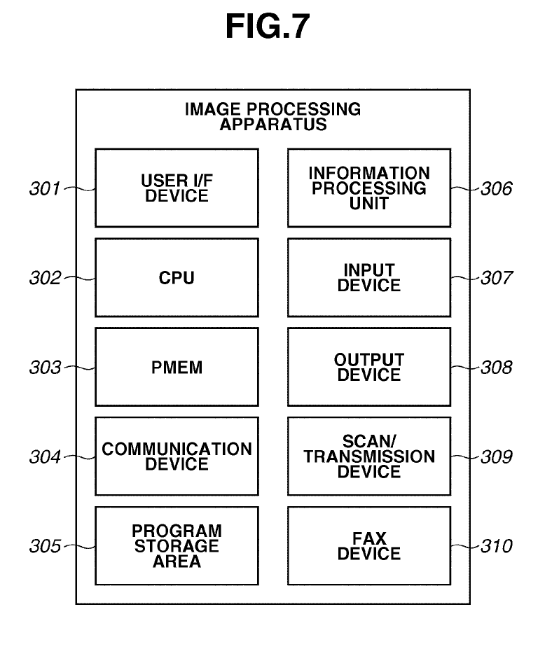

FIG. 7 is a block diagram illustrating a configuration of the image processing apparatus 13A (13B) according to the exemplary embodiment of the present invention. In the exemplary embodiment, FIG. 7 illustrates the block diagram in which all the functions are provided as far as the object of the present invention can be achieved, but a part of the functions may not be present if the functions are different depending on a used device.

The image processing apparatus 13A includes a user I/F device 301, a CPU 302, a PMEM 303, a communication device 304, a program storage area 305, an information processing unit 306, an input device 307, an output device 308, a scan/transmission device 309, and a FAX device 310.

The user I/F device 301 performs operations of devices instructed by a user or displaying information to the user. The CPU 302 executes various programs for the image processings. The PMEM 303 appropriately selects and reads the program from the program storage area 305 described below. The PMEM 203 stores the data input via the user I/F device 301 or the image data read by the input device 307 described below.

The communication device 304 establishes a connection to the network and performs data input/output control via the network. In the exemplary embodiment, the network such as local area network (LAN) is described, but a communication line connected to the communication device 304 is adaptable to a general public line.

The program storage area 305 is a device for storing the programs therein, and includes an HDD or a read-only memory (ROM). The information processing unit 306 stores and provides function information owned by the image processing apparatus 13A, and manages buttons to be displayed on the user I/F device 301.

The input device 307 performs image read processing. The output device 308 performs image data output processing. The scan/transmission device 309 scans and reads the input image data in a form of electronic data, and performs E-Mail transmission, file sharing (SMB), or a transmission processing using a protocol such as file transfer protocol (FTP). The FAX device 310 performs FAX transmission and reception.

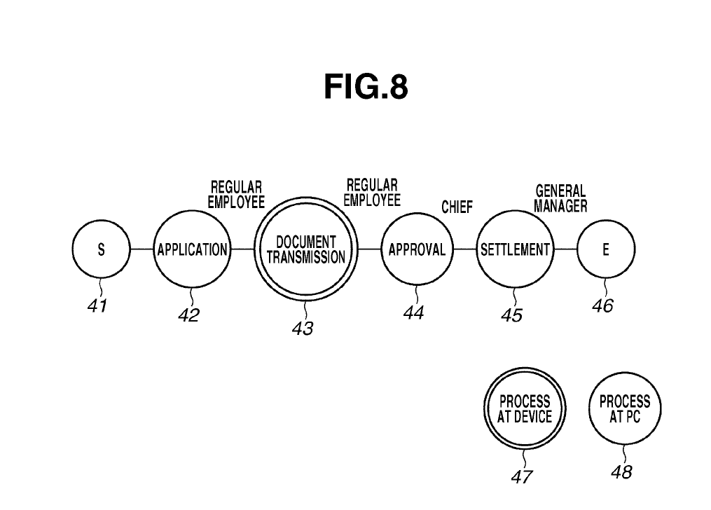

The workflow will be described. FIG. 8 illustrates an example of a process definition of a workflow according to the exemplary embodiment of the present invention. The workflow includes activities 42 to 45 between a start (S) 41 and an end (E) 46.

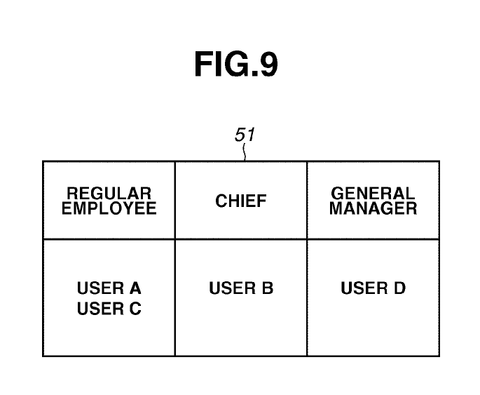

The activities 42 to 45 are classified into either one of an activity 47 to be processed in the image processing apparatus 13A (13B) and an activity 48 to be processed in the client apparatus 12. For example, in FIG. 9, the “application” activity 41, the “approval” activity 44, and the “settlement” activity 45 indicted in a solid line are the activities to be processed in the client apparatus 12. On the other hand, the “document transmission” activity 43 indicated in a double solid line is an activity to be processed in the image processing apparatus 13A.

The activities 42 to 45 are assigned the roles for specifying a user (executor) of the activity, respectively. The “application” activity 42 and the “document transmission” activity 43 are a regular employee role, the “approval” activity 44 is a chief role, and the “settlement” activity 45 is a general manager role.

The workflow management system 10 generates a work item (WI) of the user who has the role set in the activity to be subsequently processed each time each activity 42 to 45 ends. The “work item” indicates, in this description, a specific work to be performed by the user in the activity. For example, the work item of the “document transmission” activity 43 illustrated in FIG. 8 is performed by transmitting the scanned document to the workflow management server 11.

FIG. 9 illustrates an example of a relationship between a role and a user for the workflow of FIG. 8. For example, a user A and a user C have the regular employee role, and a user B and a user D have the chief role and the general manager role, respectively.

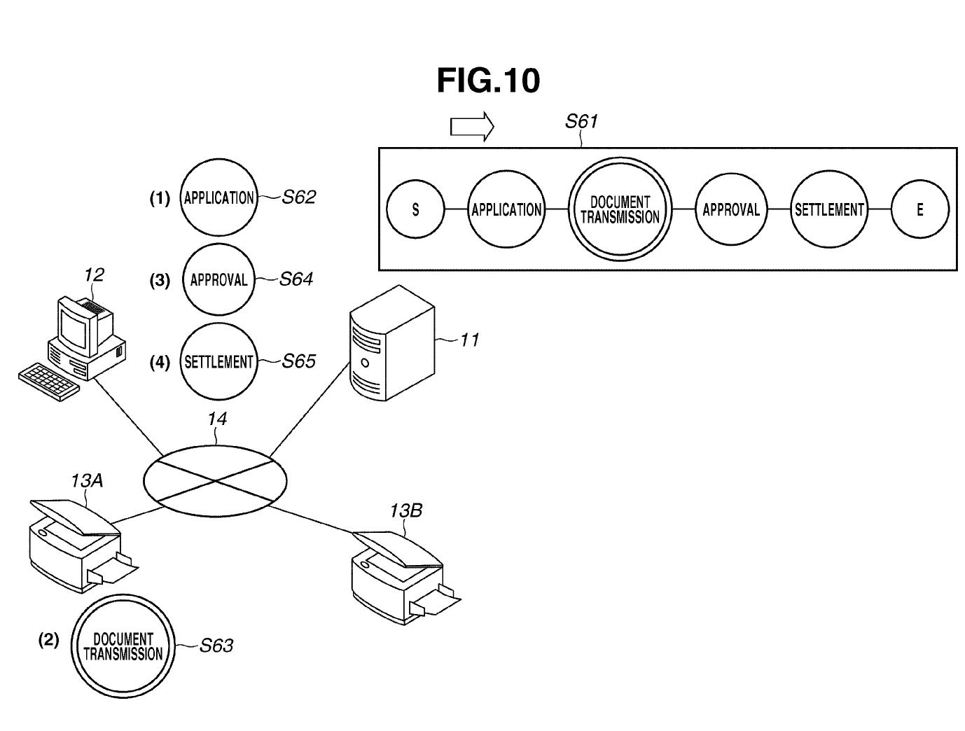

FIG. 10 is a schematic diagram illustrating an operation flow of the workflow management system 10 based on FIG. 1. In FIG. 10, the description on the parts having the same configurations as in FIG. 1 will not be repeated. A workflow S61 is the workflow illustrated in FIG. 8, and is managed by the workflow management server 11.

When the workflow S61 starts, the workflow management server 11 generates a work item of the user (such as the user A) who has the role set in the “application” activity as the first activity. In step S62, if the user A processes the “application” work item from the client apparatus 12, then in step S63, the workflow management server 11 generates a “document transmission” work item and the image processing apparatus 13A performs the processing.

The “document transmission” work item is performed by scanning the document in the image processing apparatus 13A and scanning/transmitting the same to the workflow management server 11. Then, in step S64, the user B performs the “approval” processing and, in step S65, the user D performs the “settlement” processing from the client apparatus 12 to complete the workflow 61.

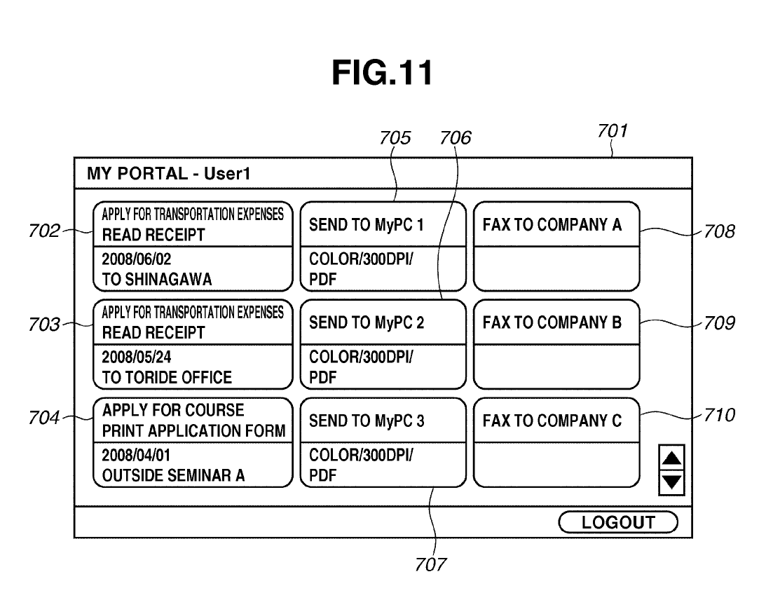

FIG. 11 illustrates an example of a portal screen displayed in the image processing apparatus 13A (13B). When each user logs in the client apparatus 12, the image processing apparatus 13A displays a portal screen 701 set for each user on the user I/F device 301. FIG. 11 illustrates an example in which a User 1 logs in.

The portal screen 701 includes operation buttons 702 to 710 for realizing the functions of the image processing apparatus 13A in one action. The setting contents of the operation buttons 702 to 710 are stored for each user in the information processing unit 306 illustrated in FIG. 7 and are displayed based on the storage information.

In FIG. 11, the operation buttons 702 to 704 are the buttons for executing the work items. The operation buttons 702 to 704 display thereon a name of workflow, a name of activity corresponding to the work item, and a comment set for the workflow. The operation buttons 705 to 710 are the buttons for executing the typical functions. More specifically, the operation buttons 705 to 707 are the buttons for performing the scanning and transmission to a specific folder. The operation buttons 708 to 710 are the buttons for transmitting a FAX to each destination.

Next, there will be described an operation flow from the work item generation to completion of the work item which is performed in the image processing apparatus 13A (13B).

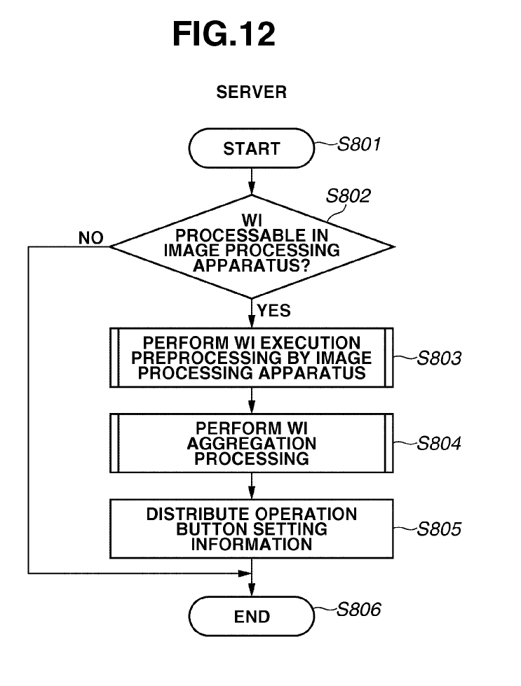

FIG. 12 is a flowchart illustrating the processing of the workflow management program after a new work item is generated to until a display button setting is distributed. Entire processing is performed in the workflow management server 11.

In step S801, the workflow is started. In step S802, after a new work item is generated, the work item processing determination unit 21 determines whether the newly generated work item is processable in the image processing apparatus. If the work item is determined to be processable in the image processing apparatus (Yes instep S802), then in step S803, the work item execution preprocessing unit 22 performs work item execution preprocessing (preparation processing) to be performed by the image processing apparatus.

Next, in step S804, the work item aggregation processing unit 23 performs a work item aggregation processing. Then, in step S805, the communication unit 28 distributes the information for setting the operation buttons for executing the work items aggregated for all the managed image processing apparatuses (distribution step), and in step S806, ends the processing.

On the other hand, when the work item is not determined to be processable in the image processing apparatus (No instep S802), then in step S806, the processing immediately ends.

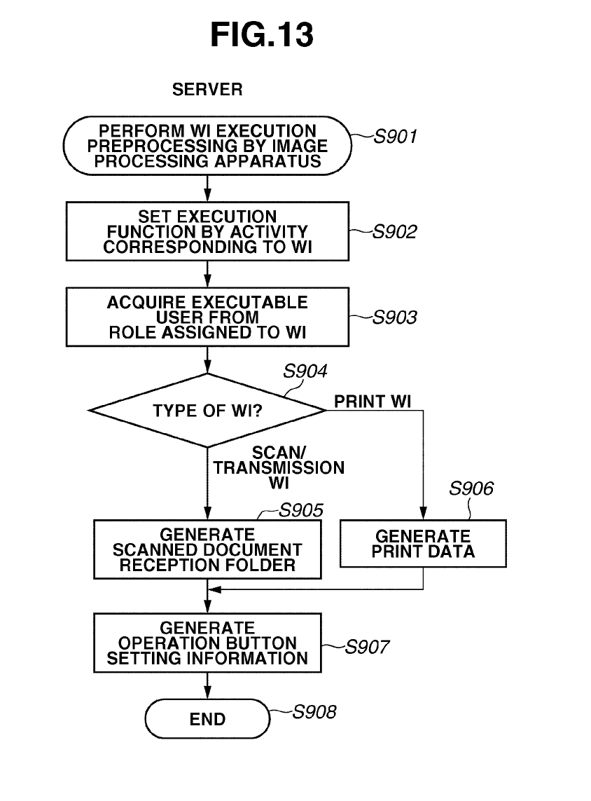

FIG. 13 is a flowchart for describing the preprocessing (step S803) in the flowchart of FIG. 12 in detail.

In step S901, when the preprocessing starts, then in step S902, the execution function setting unit 401 sets the functions to be performed in the image processing apparatus via the activities corresponding to the work items. The setting includes resolution in scanning an image, a color/monochrome setting, a scanned data file generation method, a print form (such as N-up or staple), and the like, for example.

Next in step S903, the user information acquisition unit 402 acquires information (authority) about the user who is allowed to execute the work item from the role assigned to the work item (acquisition step). According to the processing, it can be determined that which user's portal screen the operation button on which the work item setting is reflected is registered in.

Next, in step S904, the work item type determination unit 403 determines a type of the work item. More specifically, the work item type determination unit 403 determines whether the work item is for scanning and transmission or for printing.

If the work item is for scanning and transmission, then in step S905, the reception folder generation unit 404 generates a reception folder for receiving the scanned and transmitted data (generation step). The reception folder is uniquely identified for each work item in the workflow management server 11. The work item and the reception folder for storing the data relating to the work item are associated with each other and managed. Further, an access right to the reception folder is assigned only to the user acquired in step S903.

On the other hand, when the work item is for printing, then in step S906, the print data generation unit 405 generates print data (generation step). The print data is uniquely identified for each work item in the workflow management server 11. The work item and the print data associated therewith are managed in an associated manner. An access right to the print data is assigned to only the user acquired in step S903.

In step S907, the operation button information generation unit 406 generates setting information about the operation buttons to be registered in the portal screen displayed in the image processing apparatus and, in step S908, ends the preprocessing.

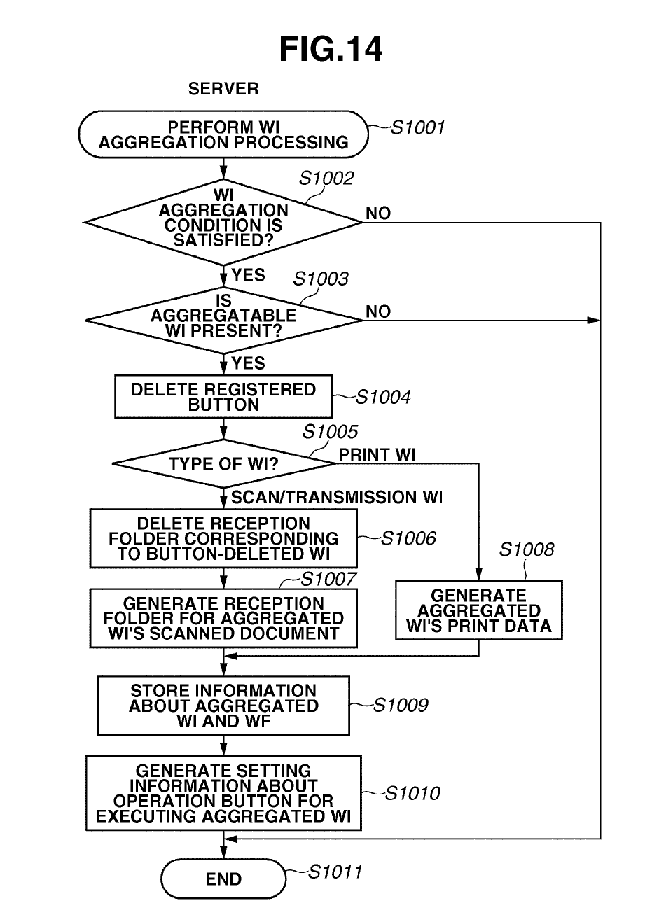

FIG. 14 is a flowchart for describing work item aggregation processing in step S804 in the flowchart of FIG. 13 in detail.

In step S1001, when the work item aggregation processing starts, then in step S1002, the aggregation condition determination unit 501 determines whether the work item satisfies the aggregation conditions. The aggregation conditions include (1) to absolutely aggregate aggregatable operation buttons, (2) to aggregate when the operation buttons cannot be all displayed on one screen, and (3) to aggregate based on a timing of generating a work item such as an old work item. The aggregation conditions are not particularly limited thereto, and in the exemplary embodiment, the aggregation conditions is set as processing “to absolutely aggregate aggregatable operation buttons”. When the work item does not satisfy the aggregation condition (No in step S1002), the processing proceeds to step S1011 and the work item aggregation processing ends.

On the other hand, in step S1002, when the work item satisfies the aggregation condition (Yes in step S1002), instep S1003, the aggregated work item detection unit 502 detects whether an aggregatable work item is present. The “aggregatable work item” is a work item of the same activity in the workflow performed in the same process definition. The user to execute the processing is the same. Thus, the work items similarly processed by the same user are aggregated. When an aggregatable work item is not present (No in step S1003), the processing proceeds to step S1011, and the work item aggregation processing ends.

On the other hand, in step S1003, when an aggregatable work item is present (Yes in step S1003), in step S1004, the operation button deletion unit 503 deletes the operation button relating to the work item to be aggregated, which is previously registered in the image processing apparatus.

Next, in step S1005, the work item type determination unit 504 determines a type of the work item. More specifically, the work item type determination unit 504 determines whether the work item is for scanning and transmission or for printing.

When the work item is for scanning and transmission (SCAN/TRANSMISSION WI in step S1005), then in step S1006, the first reception folder deletion unit 505 deletes a scanned document reception folder of the work item corresponding to the operation button deleted in step S1004. Next, in step S1007, the aggregated work item's reception folder generation unit 506 creates a scanned document reception folder for the aggregated work item (aggregation step and generation step).

On the other hand, when the work item is for printing (PRINT WI in step S1005), then in step S1008, the aggregated work item's print data generation unit 507 generates print data corresponding to the aggregated work item (generation step). A print data generation method may include a method for merging a plurality of documents into one document or a method for collectively designating and printing a plurality of documents, but is not particularly limited thereto.

Next in step S1009, the information storage processing unit 508 stores the aggregated work items and the workflow information in the storage unit 27 in an associated manner (storage step).

In step S1010, the aggregated work item's operation button information generation unit 509 generates setting information about the operation buttons for executing the aggregated work item. Then, in step S1011, the work item aggregation processing ends.

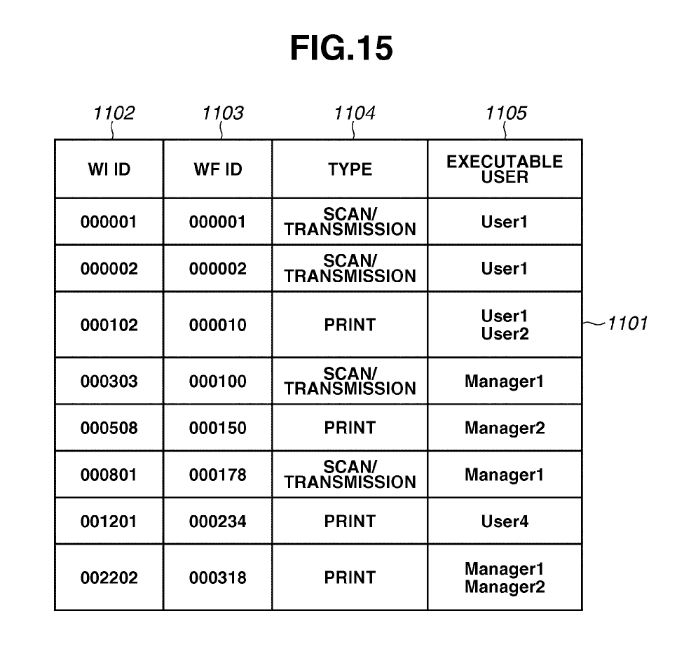

FIG. 15 illustrates information data on the work items managed by the workflow management program. Work item information data 1101 is information about the entire work items being currently executable, and includes work item (WI) ID 1102, workflow (WF) ID 1103, type information 1104, and executable user information 1105.

The WI ID 1102 is an ID for uniquely identifying a work item. The WF ID 1103 is an ID for uniquely identifying a workflow corresponding to the work item. The type information 1104 is information for identifying whether the work item is for scanning and transmission or for printing. Further, the executable user information 1105 is information indicating a user capable of executing the work item.

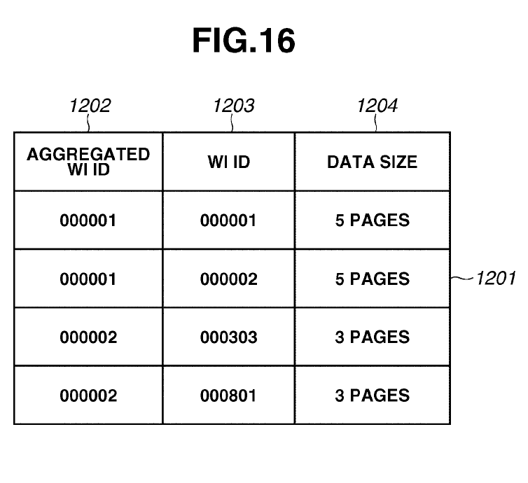

FIG. 16 illustrates information data on the aggregated work items managed by the workflow management program. Aggregated work item information data 1201 is information on the entire work items being currently aggregated, and includes aggregated WI ID 1202, WI ID 1203, and data size information 1204 corresponding to the work item.

The aggregated WI ID 1202 is information for uniquely identifying aggregation information. The WI ID 1203 is an aggregated WI ID and corresponds to the WI ID 1103 illustrated in FIG. 11. The data size information 1204 corresponding to the work item is information about a number of pages of a document to be scanned and transmitted and a number of pages of data to be printed. In the present exemplary embodiment, two WIs assigned the WI ID 1203 “0000001” and “0000002” are aggregated and stored in the aggregated WI assigned the WI ID 1202 “000001”. Similarly, two WIs assigned the WI ID 1203 “0000303” and “0000801” are aggregated and stored in the aggregated WI assigned the aggregated WI ID 1202 “000002”.

There will be described the operation buttons actually registered for executing the work items to be processed in the image processing apparatus 13A (13B).

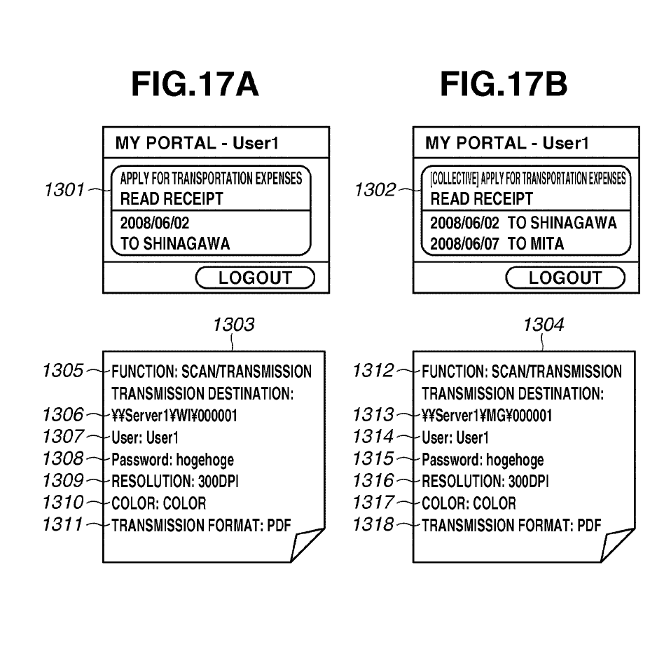

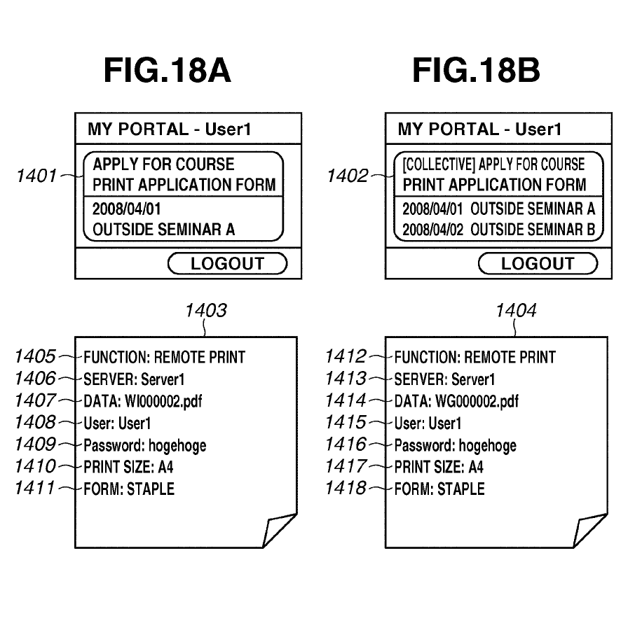

FIGS. 17A, 17B and FIGS. 18A, 18B illustrate examples of the operation buttons which are registered in the user I/F device 301 of the image processing apparatus 13A (13B) after the information for the operation button setting is distributed by the processing in step S805 of FIG. 12. FIGS. 17A and 17B illustrate the registration examples when the work item is for scanning and transmission, and FIGS. 18A and 18B illustrate the registration examples when the work item is for printing.

The registration contents of the operation buttons are stored in the information processing unit 306 of the image processing apparatus 13A. In the setting example, there are illustrated an example in which an operation button corresponding to the single work item executable by the User 1 is registered in the User 1 portal of the image processing apparatus 13A and an example in which an operation button corresponding to the aggregated work item is registered in the User 1 portal.

In FIG. 17A, a portal screen “my portal” displays thereon an operation button 1301 for the single work item. Similarly, in FIG. 17B, the portal screen “my portal” displays thereon an operation button 1302 for the aggregated work item. The operation button 1302 aggregates two work items therein, and a keyword of “collective” is assigned to its title to recognize the aggregation. The information about the two work items is listed in the information columns within the operation button 1302. In the exemplary embodiment, the display of “collective” notifies the user of the aggregation but the aggregation may be notified to the user by displaying information about a number of aggregated work items or in another displaying method.

The contents set for the operation buttons 1301 and 1302 can be specifically displayed as setting data 1303 and 1304, respectively. The setting data 1303 and 1304 respectively include function settings 1305 and 1312, transmission destinations 1306 and 1313, user names 1307 and 1314, passwords 1308 and 1315, and the settings for scanning and transmission 1309 to 1311 and 1316 to 1318.

In the examples in FIGS. 17A and 17B, the function settings 1305 and 1312 are “scanning and transmission”. The transmission destination 1306 displays a pass to the reception folder generated in step S905 of FIG. 13. Similarly, the transmission destination 1313 displays a path to the reception folder generated in step S1007 of FIG. 14. According to the paths, the work item or aggregated work item can be uniquely identified.

The user names 1307 and 1314 are an identifier for accessing each folder. By the identifier, who has executed the work item can be identified. The passwords 1308 and 1315 are a password for accessing each folder and a password corresponding to the User 1 is set in this case.

The settings 1309 to 1311 and 1316 to 1318 set therein values acquired in step S902 of FIG. 13. More specifically, the resolution 1309 and 1316 in executing the scan, the color 1310 and 1317 in executing the scan, and the transmitted data file formats 1311 and 1318 are set, respectively. The settings for scanning and transmission are not limited to those in the present exemplary embodiment, and can take all the values capable of being set in a general scanning and transmission function.

Next, in FIG. 18A, the portal screen “my portal” displays thereon an operation button 1401 for the single work item. Similarly, in FIG. 18B, the portal screen “my portal” displays thereon an operation button 1402 for the aggregated work item. The operation button 1402 aggregates two work items therein similarly to the above operation button 1302, and a keyword of “collective” is assigned to the title for recognizing the aggregation.

The contents registered in the operation buttons 1401 and 1402 can be specifically displayed as setting data 1403 and 1404, respectively. The setting data 1403 and 1404 include function settings 1405 and 1412, workflow management server information 1406 and 1413, print data 1407 and 1414, the user names 1408 and 1415, and the passwords 1409 and 1416, respectively. The setting data 1403 and 1404 further include settings 1410 to 1411 and settings 1417 to 1418 for remote print, respectively.

In the example in FIGS. 18A and 18B, the function settings 1405 and 1412 are “remote print”. The “remote print” is a function of acquiring and printing the print data present in other workflow management server or image processing apparatus. The workflow management server information 1406 and 1413 is a setting of the workflow management server in which the print data is present, namely the workflow management server 11 in the present exemplary embodiment.

The print data 1407 is print data generated in step S906 of FIG. 13, which can uniquely identify the work item. Similarly, the print data 1414 is print data generated in step S1008 of FIG. 14, which can uniquely identify the aggregated work item. A plurality of pieces of unaggregated print data are merged in one file of data in the exemplary embodiment, but a setting method for designating a plurality of pieces of the unaggregated print data may be employed.

The user names 1408 and 1415 are an identifier for accessing the workflow management server device. By the identifier, who has executed the work item can be identified. The passwords 1409 and 1416 are a password for accessing the workflow management server 11, and a password corresponding to the User 1 is set in this case.

The settings 1410 to 1411 and the settings 1417 to 1418 set therein the values acquired in step S902 of FIG. 13. More specifically, sheet sizes 1410 and 1417 for printing and print forms 1411 and 1418 are set, respectively. The remote print setting is not limited to those in the exemplary embodiment, and can take all the values capable of being set in a general remote print function.

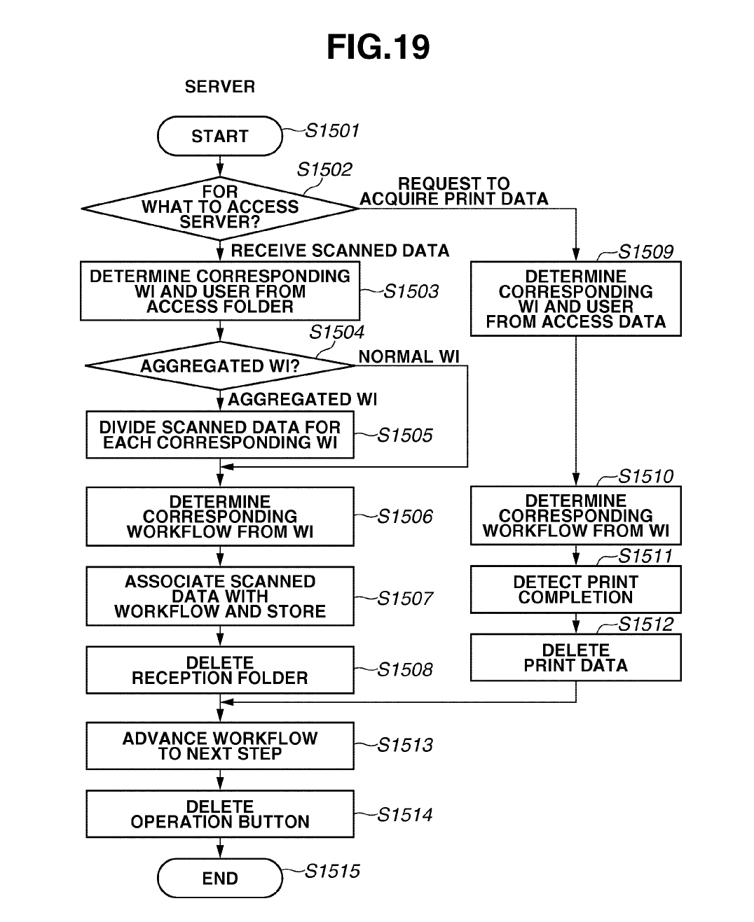

There will be described an execution monitor processing for monitoring the work item executed by the workflow management program in the workflow management server 11 and the processings after the execution monitor processing ends. FIG. 19 is a flowchart for describing the execution monitor processing according to the exemplary embodiment of the present invention and the processings after the execution monitor processing ends.

In step S1501, when the work item execution monitor processing starts (monitor step), then in step S1502, the access content determination unit 601 determines the access contents to the workflow management server 11. More specifically, the access content determination unit 601 determines whether the scanned data has been transmitted or the print data has been requested to acquire from the image processing apparatus.

When the scanned data is received, then in step S1503, the work item/user determination unit 602 detects a corresponding work item or aggregated work item from the access folder from which the data is transmitted (first detection step). At the same time, the user who has executed the work item is specified from the information about the user who has accessed the folder (first specification step).

Next, in step S1504, the aggregated work item determination unit 603 determines whether the work item is an aggregated work item. If the work item is an aggregated work item (Yes in step S1504), in step S1505, then the division unit 604 divides the received scan data to correspond to the unaggregated work items. More specifically, the received scan data is divided to generate data in units of pages based on the information about the data size 1204 of FIG. 16.

For example, when the aggregated WI ID 1202 is “000001”, the corresponding work items have the WI ID 1203 of “0000001” and “0000002”. Each data size has data for five pages, so that data for ten pages in total is collectively transmitted. The first to fifth pages in the data are divided as the data having the WI ID “0000001”, and the sixth to tenth pages are divided as the data having the WI ID “0000002”. The division method in units of pages is employed in the exemplary embodiment, but a method in which form identification is performed by optical character recognition (OCR) processing to divide the data for each form may be employed.

Next, in step S1506, the workflow determination unit 605 determines all the workflows corresponding to the work items. Then, in step S1507, the data storage processing unit 606 stores the scanned data by associating the workflow therewith in the storage unit 27. In step S1508, the second reception folder deletion unit 607 deletes the reception folder generated in step S905 of FIG. 13 or in step S1007 of FIG. 14.

In step S1513, the workflow management server 11 advances all the workflows to the next steps. In step S1514, the operation button deletion unit 503 deletes all the operation buttons distributed to and registered in the image processing apparatus in step S805 of FIG. 12. Then in step 1515, the processing ends.

On the other hand, when the determination result in step S1502 indicates the request of acquiring the print data, then in step S1509, the work item/user determination unit 602 detects a corresponding work item or aggregated work item from the requested print data (second detection step). At the same time, the user who has executed the work item is specified from the information on the user who has accessed the data (second specification step).

In step S1510, the workflow determination unit 605 determines all the workflows corresponding to the work items. When the work item is an aggregated work item, the processing is performed on all the work items based on the information about the data size 1204 of FIG. 16.

Next, in step S1511, the print completion detection unit 608 detects whether the print processing is completed in the image processing apparatus. The print processing completion detection method may employ some methods. For example, there may be employed a method in which the workflow management server 11 checks a print job status of the image processing apparatus or a method in which a printed data deleting function for emote print is utilized to delete the data in response to a data deletion request from the image processing apparatus.

Then, in step S1512, the print data deletion unit 609 deletes the print data. The processings after step S1513 are as described above.

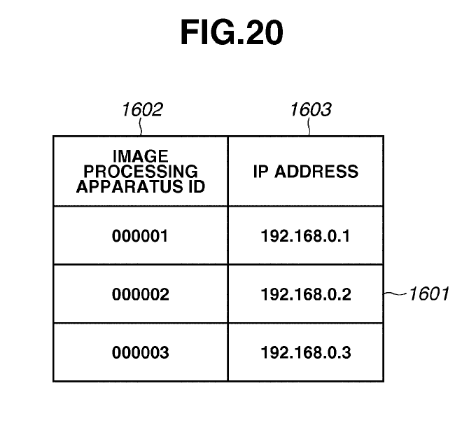

The information about the image processing apparatus managed by the workflow management server 11 will be described below. FIG. 20 illustrates an example of information data about the image processing apparatus. The workflow management server 11 performs button distribution processing in step S805 of FIG. 12 based on the information data.

Information data 1601 about the image processing apparatus includes an ID 1602 for uniquely identifying the image processing apparatus and an IP address 1603 of the image processing apparatus which are the entire information for collectively managing the registered image processing apparatuses. The IP address 1603 is utilized for network communication. The information data generation method is not particularly limited to the exemplary embodiment. For example, there can be employed a method in which a system manager previously registers the image processing apparatuses, a method for automatically registering a group of image processing apparatuses utilizing the same authentication workflow management server, or a method for automatically registering the image processing apparatuses within the same subnet.

As described above, according to the exemplary embodiment of the present invention, the operation buttons on the image processing apparatus can be displayed or deleted according to the progress of the workflow, so that the execution work item of the image processing apparatus can be processed. Further, aggregation of the operation buttons and collective execution of the work items can be enabled for collectively processing a plurality of the work items.

The present invention is not limited to the exemplary embodiment, and each constituent maybe alternatively replaced as far as the object of the present invention can be achieved.

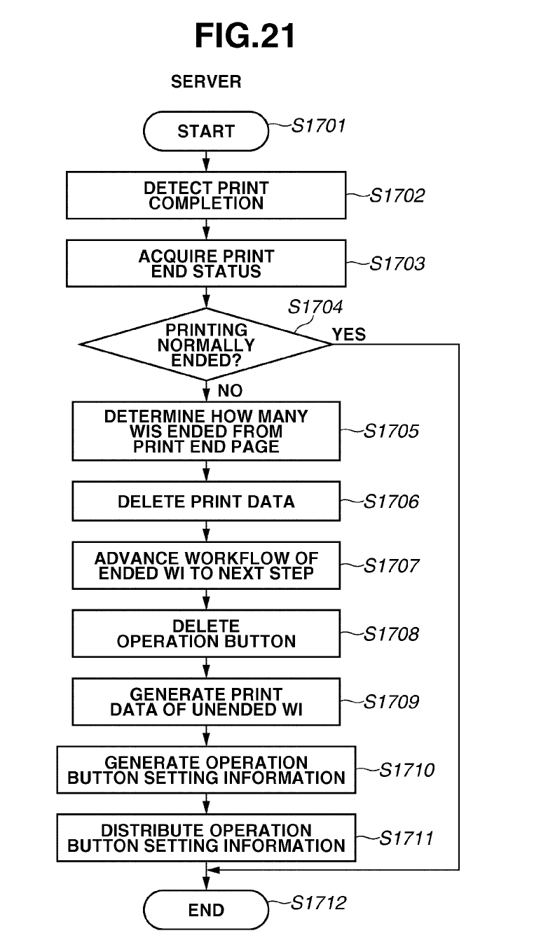

FIG. 21 is a flowchart for describing another exemplary embodiment of the processings from step S1511 to step S1513 of FIG. 19. More specifically, FIG. 21 is a flowchart of the processing in which the workflow management server 11 acquires a detailed print status of the print processing collectively performed in the image processing apparatus, and even if an error occurs during the printing, advances the workflow to the work item of the print completed data.

In step S1701, the processing is started. Then in step S1702, the print completion detection unit 608 detects the print completion in the image processing apparatus. Next in step S1703, the print status acquisition unit 610 acquires the status when the printing ends (status acquisition step). More specifically, the print status comprehension unit 611 determines whether the printing has normally ended. When the printing is not normally ended, the print status comprehension unit 611 acquires the status indicating how many pages have been printed.

In step S1704, the print status comprehension unit 611 determines whether the printing has normally ended. When the printing has normally ended (Yes in step S1704), the processing proceeds to step S1712, and the processing ends.

On the other hand, when the printing has not normally ended (No in step S1704), then in step S1705, the print status comprehension unit 611 specifies how many work items have ended based on the print end page (third specification step).

For example, in the information data 1201 illustrated in FIG. 16, when the aggregated WI ID 1202 is “000001”, the data for ten pages in total is present, where the first to fifth pages are the data having the WI ID 1203 of “0000001” and the sixth to tenth pages are the data having the WI ID 1203 of “0000002”. In this case, if the printing has ended in error, when the printing has completed until the fifth page, the printing has completed until the work item having the WI ID 1203 of “0000001”.

Next, in step S1706, the print data deletion unit 609 deletes the print data. In step S1707, the workflow management server 11 advances the workflow corresponding to the ended work item determined in step S1705 to the next step. In step S1708, the operation button deletion unit 503 (see FIG. 5) deletes all the operation buttons distributed to and registered in the image processing apparatus in step S805 of FIG. 12.

In step S1709, the print data generation unit 405 (see FIG. 4) regenerates the print data of the uncompleted work item determined in step S1705 (regeneration step). Then, in step S1710, the operation button information generation unit 406 (FIG. 4) generates the information for determining the setting contents of the operation buttons to be registered in the portal screen of the image processing apparatus. Finally, in step S1711, the communication unit 28 distributes the information for the operation button setting to all the managed image processing apparatuses, and in step S1712, the processing ends.

For example, when the printing has ended until the fifth page in the aggregated WI ID 1202 of “000001” in the above example, the work item having the WI ID 1203 of “0000002” has not been printed yet. Thus, the print data generation and button distribution corresponding to the work item having the WI ID 1203 of “0000002” is performed. In this case, the button changes from the aggregated work item to the normal work item. However, if a plurality of unprinted work items is present, the unprinted work items are processed again as the aggregated work item.

As described above, according to the exemplary embodiment of the present invention, aggregation and collective execution of a plurality of work items can be realized in the workflow management system which displays and deletes the operation buttons on the image processing apparatus according to the progress of the workflow and controls execution.

The present invention can be realized in various forms without departing from the scope or principal features. Thus, the above exemplary embodiment is merely illustrative in all viewpoints, and should not be interpreted in a limited manner.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-003957, filed Jan. 9, 2009, which is hereby incorporated by reference herein in its entirety.

What is claimed is:

1. A workflow management server which can be connected to a network and manage a workflow to be executed in an image processing apparatus connected to the network, the workflow management server comprising:
an execution function setting unit configured to set a function to be executed in the image processing apparatus according to an activity which is a work unit in a workflow and corresponds to a work item as specific work to be executed by a user;
a user information acquisition unit configured to acquire information about a user who is allowed to execute the work item from a role assigned to the work item;
an operation button information generation unit configured to generate information for determining setting contents of an operation button to be registered in a portal screen of the image processing apparatus based on the work item and the user information acquired by the user information acquisition unit;
an aggregation condition determination unit configured to determine whether the work item satisfies previously set aggregation conditions;
an aggregated work item detection unit configured to detect whether an aggregatable work item is present;
an operation button deletion unit configured to delete an operation button associated with a work item to be aggregated which is previously registered in the portal screen of the image processing apparatus;
an aggregated work item's operation button information generation unit configured to generate information for determining setting contents of an operation button for executing an aggregated work item registered in the portal screen of the image processing apparatus based on the information generated by the operation button information generation unit according to a detection result of the aggregated work item detection unit; and
a communication unit configured to transmit the information generated by the aggregated work item's operation button information generation unit to the image processing apparatus.

2. The workflow management server according to claim 1, further comprising an image processing apparatus management unit configured to manage information data for collectively managing a plurality of image processing apparatuses connected to the network.

3. The workflow management server according to claim 1, further comprising:
a print status acquisition unit configured to acquire a print status of the image processing apparatus; and
a print status comprehension unit configured to comprehend a status indicating whether the printing has normally ended based on the print status,
wherein the operation button deletion unit deletes the operation button previously registered in the portal screen of the image processing apparatus when the print status comprehension unit comprehends that the printing has not normally ended.

4. A workflow management system, comprising:
a client apparatus which a user instructs to perform workflow processing;
a workflow management server according to claim 1; and
an image processing apparatus which includes the user-specific portal screen, and has a function of registering or deleting an operation button for executing scanning and transmission or printing displayed on the portal screen based on an instruction from the workflow management server.

5. A method for managing a workflow executed in a workflow management system which includes a client apparatus which a user instructs to perform workflow processing, a workflow management server configured to execute the workflow based on an instruction from the client apparatus, and an image processing apparatus which includes the user-specific portal screen, and has a function of registering or deleting an operation button for executing scanning and transmission or printing displayed on the portal screen based on an instruction from the workflow management server, the method comprising:
aggregating setting information about a plurality of the operation buttons;
storing the aggregated operation button setting information and a plurality of work items corresponding to the aggregated operation button setting information by associating each other; and
registering an operation button for executing an aggregated work item in the portal screen based on the aggregated operation button setting information.

6. The method according to claim 5, further comprising monitoring the work item processed by the image processing apparatus.

7. The method according to claim 5, further comprising:
acquiring an authority of a user capable of executing the work item; and
registering an operation button which reflects the work item setting, in a portal screen of the authorized user based on the acquired authority.

8. The method according to claim 5, further comprising generating a reception folder for receiving scanned and transmitted data or generating print data for print based on the work item information.

9. The method according to claim 5, further comprising:
detecting an execution of a work item for scanning and transmission based on a fact that the data is stored in the reception folder of the workflow management server; and
when the execution of the work item for scanning and transmission is detected, specifying which user has executed the work item on the reception folder of the workflow management server.

10. The method according to claim 5, further comprising:
detecting an execution of a work item for print by accessing print data of the workflow management server or monitoring print completion of the image processing apparatus; and
when the execution of the work item for print is detected, specifying which user has executed the work item on the print data of the workflow management server.

11. The method according to claim 5, further comprising:
acquiring a print status of print processing collectively executed in the image processing apparatus;
when an error occurs during the print processing, specifying a work item corresponding to a page at which the print processing ends;
regenerating the operation buttons of the image processing apparatus, the setting of the print processing, and the print data of the workflow management server based on a status of the work item for which the print processing ends.

12. A computer readable storage medium storing a program for causing a computer to execute a method according to claim 5.
